(19) United States
(12) Patent Application Publication
(10) Pub. No.: US 2023/0286246 A1
(43) Pub. Date: Sep. 14, 2023

(54) THERMALLY FUSIBLE SHEET MATERIAL WITH BIODEGRADABLE BONDING COMPOUND

(71) Applicant: Carl Freudenberg KG, Weinheim (DE)

(72) Inventors: Steffen KREMSER, Heddesheim (DE); Mauro DAVANZO, Ludwigshafen (DE)

(21) Appl. No.: 18/183,287

(22) Filed: Mar. 14, 2023

(30) Foreign Application Priority Data
Mar. 14, 2022 (DE) 10 2022 105 897.2

(51) Int. Cl. B32B 5/02; B32B 5/26; B32B 7/14

(52) U.S. Cl. CPC B32B 5/024; B32B 5/262; B32B 5/022; B32B 7/14; B32B 2262/062; B32B 2262/0276; B32B 2262/148; B32B 2307/718; B32B 2255/02; B32B 2255/26; B32B 2307/7163; B32B 2479/00; B32B 2437/02; B32B 2605/00; B32B 2419/00; B32B 2250/02; B32B 2250/20; B32B 2432/00

(57) ABSTRACT

A thermally fusible sheet material, comprising a backing ply composed of a textile material and bearing a bonding compound structure, wherein the bonding compound structure comprises at least one polyalkylene succinate as hotmelt adhesive, and a process for making the same.

This application claims priority to German Patent Application No. DE 10 2022 105 897.2, filed on Mar. 14, 2022, the entire disclosure of which is incorporated by reference herein.

The invention relates to a thermally fusible textile sheet material which is usable especially as a fusible interlining, lining and/or outer fabric in the textile industry. The invention further relates to the use of the textile sheet material in the textile industry, especially as interlining, lining and/or outer fabric for production of clothing, and for production of furniture, cushioning, domestic textiles, components for vehicle equipment and for the construction sector, shoes, filters and further industrial applications.

### BACKGROUND OF THE INVENTION

Interlining (also referred to as fusible material or lining material) generally includes a textile sheet material (a backing ply composed of a textile material), wherein at least one of the surfaces has been at least partly coated with a bonding compound. The bonding compound enables permanent bonding of the interlining to a further substrate, for example a textile or leather material to be fused. This imparts stability to the fused substrates, protects from unwanted loss of shape, for example as a result of extension, and has the effect of greater or lesser stiffening depending on the material. As such, interlining finds wide use in the clothing sector for production of women's and men's clothing, casualwear, sportswear and functional clothing, workwear and protective clothing, children's clothing, underwear, nightwear, etc. As well as the production of clothing, interlining is also used in other sectors, for example the production of furniture, cushioning, domestic textiles, components for vehicle equipment and for the construction sector shoes, filters and further industrial applications.

In the clothing sector, depending on the field of use, a distinction is made between interlining in the narrower sense and linings and outer fabrics. Interlining in the narrower sense is in the interior of most items of clothing and is the invisible framework of the clothing. They ensure correct fits and optimal wearing comfort. Depending on the application, they assist processibility, increase functionality and stabilize the clothing.

Typical areas of use are collars, button plackets and cuffs of shirts and blouses, the front portions of suit jackets and blazers, the waistband of skirts and trousers, and the shoulders. Lining fabrics refers to textile sheet materials that are secured to the insides of textiles. It is increasingly the case that this is being accomplished not, or not exclusively, by conventional joining methods such as sewing or stitching, but by fusion with a bonding compound structure. A lining is the inner material layer of the outerwear that faces the body. Lining can have the function of making the inside of an item of clothing more durable, more comfortable and/or warmer, or else of imparting a particular finish. For instance, linings of clothing in many cases also have a fashionable aspect. Apart from items of clothing, linings are also used in hats, suitcases, handbags and other vessels. Outer fabrics (also denoted as shells or upper fabrics) are fabrics that are used as the material layer of textiles visible from the outside.

The textile sheet material generally consists of nonwoven fabrics, woven fabrics, knitted fabrics, warp-knitted fabrics or comparable fabrics. The different textile sheet materials mentioned have different profiles of properties depending on the processes by which they are produced. Woven fabrics consist of filaments/yarns in warp and weft direction; knits consist of filaments/yarns that are knitted to form a textile sheet material. Nonwoven fabrics consist of individual fibres laid out to form a fibre web that are bonded mechanically, chemically or thermally. In order to make the textile sheet materials thermally fusible, they are generally provided with a bonding compound, which means that they can be bonded to a further component by a cohesive bonding method, for example thermally and/or by means of pressure. It is thus possible, for example, to laminate an interlining, for example, onto an outer fabric. For this purpose, the bonding compound generally includes at least one hotmelt adhesive.

Hotmelt adhesives have long been known. They are generally understood to mean essentially solvent-free products which can be applied to an adherend in the molten state, solidify rapidly on cooling and hence quickly build up strength. The fundamental basis of the bonding effect of the hotmelt adhesives is that, being thermoplastic polymers, they can be melted reversibly and, as a liquid melt, on account of their lowered viscosity by virtue of the melting operation, are capable of wetting the surface to be bonded and hence developing adhesion therewith. As a result of the subsequent cooling, the hotmelt adhesive solidifies again to the solid state, which has high cohesion and in this way establishes the bond to the adherend. Once bonding has taken place, the viscoelastic polymers ensure that adhesion is preserved even after the cooling operation with its changes in volume and the associated buildup of mechanical stresses. The cohesion built up mediates the bonding forces between substrates.

WO 2013/162058 describes a hotmelt adhesive comprising:
A) a conjugated diene-based polymer modified with polar functional groups,
B) an aliphatic polyester-based resin,
C) an adhesive resin.

Component B) may, inter alia, also be a polybutylene succinate. The hotmelt adhesives described are said to be suitable for paper processing, for bookbinding and for disposable products, and to have good adhesion even in the moist state. The disposable articles are sanitary products, such as disposable nappies, sanitary towels, pet bedding sheets, hospital gowns, operation gowns, urine bags, pregnancy pants, nursing pads and underarm perspiration pads. For production of the disposable articles, fibre materials and polymer films may be bonded to one another.

This document does not describe the use of the hotmelt adhesive for thermally fusible textile sheet material which is used especially as fusible interlining, lining and/or outer fabric in the textile industry, and specifically for production of clothing. These fusible materials and the textiles equipped therewith are not disposable products, but generally high-quality products, and the use of the fusible materials serves to preserve shape and protects from wear and weathering influences, thus extending the life of the products. In the production and finishing of textiles with interlining and fusible materials, the materials are not bonded directly to one another; instead, the intermediate products mentioned are used, on which a bonding compound structure is still in a bondable (unbonded, uncured) state.

In particular, WO 2013/162058 does not describe a method by which a bonding compound structure can be applied to a backing ply composed of textile material, and so this can subsequently be bonded to a further textile component by a cohesive bonding method, for example thermally and/or by means of pressure, such as scattering methods, powder point methods, paste print methods, double point methods, hotmelt methods, inkjet methods, etc.

CN 108265394 A describes meltblown nonwovens made from polybutylene succinate fibres and the use thereof as biocompatible and available materials, specifically filter materials, materials for environmental protection, etc. There is no description of use of polybutylene succinate as component of a bonding compound structure for thermally fusible sheet material.

JP 2006 205644 A describes polymer sheets lined with woven or nonwoven fabrics. For production, the textile materials may be laminated to the polymer sheet with the aid of a polybutylene succinate resin.

WO 2009/059801 describes a thermally fusible sheet material usable as fusible interlining in the textile industry, having a backing ply composed of a textile material and bearing a two-ply bonding compound structure comprising a binder and a thermoplastic polymer. The thermoplastic polymer functions as the actual bonding agent and is preferably selected from (co)polyester-, (co)polyamide-, polyolefin-, polyurethane-, ethylene/vinyl acetate-based polymers and mixtures and copolymers of the polymers mentioned. The binder may be a binder of the acrylate, styrene acrylate, ethylene-vinyl acetate, butadiene-acrylate, SBR, NBR and/or polyurethane type.

WO 2013/001309 describes a sheet material, especially for use as fusible interlining in the textile industry, having a backing ply composed of a textile material and bearing a bonding compound structure comprising a polyurethane hotmelt adhesive composition containing a thermoplastic polyurethane.

WO 2016/169752 describes a thermally fusible sheet material having a backing ply composed of a textile material and bearing a polyurethane foam coating.

WO 2019/081696 describes a thermally fusible sheet material bearing a bonding compound structure comprising a polyurethane mixture including at least one polyesterurethane (B1), at least one polyetherurethane (B2) and at least one polycarbonateurethane (B3), and wherein the polyurethane mixture has been at least partly crosslinked with a crosslinker having at least one blocked isocyanate group.

DE 10 2019 106995 describes a thermally fusible textile sheet material, especially usable as fusible interlining, lining and/or outer fabric in the textile industry, comprising a backing material based on a meltblown fibre nonwoven, wherein the backing material has floc fibres on one side and a hotmelt adhesive on the side remote from the floc fibres.

WO 2015/106903 describes a thermally fusible sheet material having anisotropic properties with a backing ply composed of a fibre web or a nonwoven material bearing a thermally softenable bonding compound and a binder, wherein the fibres in the backing ply, at least in some regions, have anisotropic orientation with formation of a preferential direction, and the binder and/or the bonding compound is distributed such that there is a greater amount of binder and/or bonding compound in the preferential direction of the fibres than transverse to the preferential direction of fibres. The bonding compound contains at least one conventional hotmelt adhesive selected from thermoplastic polymers such as polyamides, copolyamides, polyesters, copolyesters, ethylene/vinyl acetate polymers, polyolefins (such as polyethylene, polypropylene and amorphous polyalphaolefins) and polyurethanes.

WO 2015/161964 describes a thermally fusible sheet material having a backing ply composed of a textile material and bearing a two-ply bonding compound structure comprising a lower layer directly adjoining the sheet material and an upper layer disposed atop the lower layer. The lower layer contains a first hotmelt adhesive having a melting point >140° C. and a melt flow index (MFI) of >50 g/10 minutes (190° C./2.16 kg), and the upper layer contains a second hotmelt adhesive having a melting point of <145° C. and an MFI of <50 (190° C./2.16 kg).

High demands are made on thermally fusible sheet materials, specifically for interlining in the clothing industry, but also for other industrial textile applications. The desired profile of properties is complex and includes, as well as the mere fusion properties, demands on further material properties as well (such as softness, springiness, pleasant hand), durability (e.g. abrasion resistance in use) and care. In particular, there is a demand for thermally fusible sheet materials having high resistance to washing and dry cleaning.

In addition, there is currently a great demand for interlining for various applications that meets environmental demands on the use of sustainable materials. As well as the use of renewable raw materials and an environmentally acceptable production process, these include, in particular, biodegradability/compostability of all components if possible. Such interlining is an important intermediate product for production of clothing that consists exclusively as far as possible of biodegradable/compostable components. In the provision of such biodegradable/compostable interlining, the remaining profile of properties, specifically wash resistance (hydrolysis stability) and dry cleaning stability, should not be deteriorated compared to conventional products.

It has now been found that, surprisingly, this object is achieved by a thermally fusible sheet material comprising at least one polyalkylene succinate as hotmelt adhesive.

### SUMMARY OF THE INVENTION

The invention firstly provides a thermally fusible sheet material, comprising a backing ply composed of a textile material and bearing a bonding compound structure, wherein the bonding compound structure comprises at least one polyalkylene succinate as hotmelt adhesive.

The bonding compound structure preferably comprises
i) at least one polyalkylene succinate,
ii) optionally at least one hotmelt adhesive other than the polyalkylene succinates i),
iii) optionally at least one polymeric binder other than the hotmelt adhesives i) and ii),
iv) optionally at least one additive.

The invention further provides a process for producing a thermally fusible sheet material as defined above and hereinafter, comprising providing a backing ply composed of a textile material and applying a bonding compound structure by an application method selected from spreading methods, powder point methods, paste print methods, double point methods, hotmelt methods, inkjet methods and combinations thereof.

The invention further provides an item of clothing comprising a thermally fusible sheet material as defined above and hereinafter in thermally fused form. The item of clothing is preferably selected from men's clothing, women's clothing, girls' clothing, boys' clothing, children's clothing, underclothing (underwear), outerwear, spring clothing, summer clothing, autumn clothing, winter clothing, outdoor clothing, indoor clothing, protective clothing, workwear, legwear, armwear, skirtwear, torsowear, single-sided, double-sided, lined and unlined clothing, semifinished items of clothing and clothing accessories.

The invention further provides for the use of a thermally fusible sheet material as defined above and hereinafter as interlining, lining or outer fabric for production of textile products, especially in the form of clothing, upholstered furniture, carpets, bed and table covers, curtains, towels, cleaning cloths, filters, meshes, and for production of footwear, medical and hygiene textiles, components for vehicle equipment and the construction sector, and different industrial textiles.

### DESCRIPTION OF THE INVENTION

Unless more specific details are given hereinafter, the expression “interlining” is interpreted broadly and also includes linings and outer fabrics.

The thermally fusible sheet material according to the invention comprises a backing ply composed of a textile material, which is also referred to in the context of the invention as textile sheet material. This backing ply or the textile sheet material generally consists of nonwoven fabrics, woven fabrics, knitted fabrics, warp-knitted fabrics or any combinations of these fabrics.

A polymer material is considered to be biodegradable when at least 60% of the organic carbon is converted in the laboratory test within not more than six months. According to the provisions of DIN EN 13432:2000-12 relating to compostability, the products must be decomposable within not more than 90 days in an industrial composting system to an extent of 90% to give fragments of less than 2 mm.

Melt flow index (MFI), also referred to as melt mass flow rate (MFR), characterizes the flow characteristics of thermoplastic polymers as used in accordance with the invention as hotmelt adhesive. Melt mass flow rate can be determined by the method described in DIN EN ISO 1133-1:2012-03. The MFR of the polymers used as hotmelt adhesive influences the processibility of the polymers and the adhesion values (bond strength) of the resulting thermally fusible sheet material.

The melting temperature of the polyalkylene succinates and of semicrystalline thermoplastic polymers in general can be determined by DSC (differential scanning calorimetry). Corresponding methods are described in DIN EN ISO 11357-1:2017-02.

The basis weight of textile materials, such as nonwovens, in g/m² can be determined according to ISO 9073-1:1989-07 (German version: EN 29073-1:1992) or ASTM D6242-98 (2004).

One measure of the strength of the composite composed of an interlining and the material fused thereto is bond strength according to DIN 54310:1980-07. The force required for the separation of the fused interlining from the outer fabric is reported in N/5 cm. The thermally fusible sheet material according to the invention is notable for a high bond strength, measured to DIN 54310:1980-07, preferably at least 5 N/5 cm, more preferably at least 10 N/5 cm.

The thermally fusible sheet materials used in accordance with the invention are particularly advantageously suitable for the production of clothing consisting mainly, and especially exclusively, of biodegradable/compostable components. They are notable for high stability to washing and dry cleaning. It has been found that, surprisingly, the composite composed of the sheet material according to the invention and a substrate bonded thereto is notable for a high bond strength. This is maintained even in the case of repeated washing and dry cleaning. Furthermore, thermally fusible sheet materials according to the invention may be processed without difficulty with customary fusion presses, they show very good tactile and optical properties, are easily and inexpensively producible, and also tolerate drying conditions with high numbers of cycles.

Bonding Compound Structure

The bonding compound structure serves to permanently bond the backing ply to another material. For this purpose, the bonding compound structure contains at least one hotmelt adhesive, generally comprising thermoplastic polymers. In a preferred embodiment, the polymers used as hotmelt adhesive are thermally activatable, i.e. heating enhances bond strength, generally considerably. Without being bound to any theory, the increase in bond strength through activation may be based, for example, on better wettability of the substrates to be bonded and/or better entanglement of the polymer chains with one another and/or with the substrate surface. According to the invention, the hotmelt adhesive comprises at least one polyalkylene succinate as defined in detail hereinafter.

In addition to at least one hotmelt adhesive, the bonding compound structure may contain at least one binder. Binders in the context of the invention are polymers other than hotmelt adhesives, and they may preferably be physically crosslinking binders and/or chemically crosslinking binders.

The present invention preferably provides a thermally fusible sheet material comprising a bonding compound structure comprising
i) at least one polyalkylene succinate,
ii) optionally at least one hotmelt adhesive other than the polyalkylene succinates i),
iii) optionally at least one polymeric binder other than the hotmelt adhesives i) and ii),
iv) optionally at least one additive.

In a specific embodiment, the bonding compound structure does not contain any conjugated diene-based polymer modified with polar functional groups. This means that these are not used as hotmelt adhesive other than the polyalkylene succinates i), nor as polymeric binder iii), nor as additive iv). This applies both to conjugated diene-based polymers modified with polar functional groups in non-hydrogenated form and in hydrogenated form. In particular, the bonding compound structure does not contain any conjugated diene-based polymer modified with polar functional groups, where the conjugated diene-based polymer comprises a block copolymer, specifically a styrene-ethylene/propylene-styrene (SEPS) block copolymer or a styrene-ethylene/butylene-styrene (SEBS) block copolymer, more specifically amino group-modified SEBS or maleic acid-modified SEBS.

According to the invention, the bonding compound structure comprises at least one hotmelt adhesive containing a polyalkylene succinate (component i)).

The polyalkylene succinate is preferably selected from the polycondensation products of succinic acid with at least one polyol selected from butane-1,4-diol, butane-2,3-diol, propane-1,3-diol, propane-1,2-diol, ethylene glycol and mixtures thereof.

The polyalkylene succinate is preferably selected from poly-1,4-butylene succinate (also referred to as polybutylene succinate PBS), polyethylene succinate, poly-1,2-propylene succinate, poly-2,3-butylene succinate, poly-1,3-propylene succinate (P1,3PS) and mixtures thereof.

In particular, the bonding compound structure comprises at least one polybutylene succinate.

Polybutylene succinate is biodegradable and compostable and can be obtained by reaction of succinic acid with butane-1,4-diol. The starting materials (succinic acid and butane-1,4-diol) are producible from glucose and hence from renewable raw materials. Polybutylene succinate is commercially available, for example in the form of the BioPBS brands from Mitsubishi Chemical Performance Polymers (MCPP).

The polyalkylene succinates and especially polybutylene succinates are particularly advantageously suitable for use as hotmelt adhesive for thermally fusible sheet materials. They have melting indices and melting points that are especially suitable for use as fusible interlining, lining and/or outer fabric in the textile industry.

The bonding compound structure preferably contains at least one polyalkylene succinate having a melt flow index (MFI), determined according to DIN EN ISO 1133-1 at 190° C. and a load of 2.16 kg, of 1 to 200 g/10 minutes, preferably of 5 to 120 g/10 minutes, especially of 10 to 80 g/10 minutes.

In particular, the bonding compound structure contains at least one polybutylene succinate having a melt flow index (MFI), determined according to DIN EN ISO 1133-1 at 190° C. and a load of 2.16 kg, of 1 to 200 g/10 minutes, preferably of 5 to 120 g/10 minutes, especially of 10 to 80 g/10 minutes.

The bonding compound structure preferably contains at least one polyalkylene succinate having a melting point in the range from 60 to 190° C., preferably from 90 to 150° C., especially from 100 to 130° C.

In particular, the bonding compound structure contains at least one polybutylene succinate having a melting point in the range from 60 to 190° C., preferably from 90 to 150° C., especially from 100 to 130° C.

The polyalkylene succinates and especially the polybutylene succinates are particularly advantageously suitable for thermally fusible sheet materials having high resistance to washing and dry cleaning. They give good bond strength values even after multiple care treatments.

The polyalkylene succinates and especially the polybutylene succinates, as a result of their preparation, have a particular particle size distribution and a corresponding average particle size. For use as hotmelt adhesive, it may be advantageous to adjust the average particle size and particle size distribution to the respective fields of use. For instance, especially in the various methods of applying the bonding compound structure to the backing ply that are described hereinafter, it may be advantageous when the hotmelt adhesive(s) has/have a particle size and particle size distribution matched to the respective method. The polyalkylene succinates and especially the polybutylene succinates are notable for good grindability. An especially suitable method of grinding thermoplastic polymers for hotmelt adhesives, which is also advantageously suitable for polyalkylene succinates and especially polybutylene succinates, is cryogenic grinding. This involves cooling the material for grinding by treatment with a coolant, for example with liquid nitrogen. In order to establish the desired particle size and particle size distribution, the material for grinding may be subjected to a separation, for example by means of suitable sieving methods. In order to adjust the product properties, it is also possible to use blends of two or more hotmelt adhesives. The individual components of the blend may differ in particle size, in another physicochemical property and/or in chemical composition.

The bonding compound structures used in the thermally fusible sheet materials according to the invention preferably contain polyalkylene succinates having an average particle size in the range from >0 to 1000 μm (micrometres), more preferably of 10 to 800 μm. Preference is given to polybutylene succinates having an average particle size in the range from >0 to 1000 μm, more preferably from 10 to 800 μm.

For application of the bonding compound structure to the backing ply by paste printing, preference is given to using an aqueous dispersion containing at least one polyalkylene succinate, especially at least one polybutylene succinate, having an average particle size of >0 to 100 μm. For paste printing, particular preference is given to an average particle size of >0 to 80 μm.

For application of the bonding compound structure to the backing ply by a spreading method, preference is given to using at least one polyalkylene succinate, especially at least one polybutylene succinate, having an average particle size of 50 to 300 μm. For spreading application, particular preference is given to an average particle size of 80 to 250 μm. For a spreading method, the particle composition preferably includes essentially no dust component of particles having a particle size of less than 80 μm. This dust component is preferably not more than 2% by weight, more preferably not more than 1% by weight, based on the total weight of the polymer particles.

For application of the bonding compound structure to the backing ply by a powder point method, preference is given to using at least one polyalkylene succinate, especially at least one polybutylene succinate, having an average particle size of >0 to 500 μm.

Suitable further hotmelt adhesives (=component ii)) are thermoplastic polymers other than polyalkylene succinates, preferably selected from polyesters, polyolefins, polyamides, polyurethanes, polyacrylates, styrene-isoprene copolymers, styrene-butadiene copolymers, ethylene-vinyl acetate copolymers and mixtures (blends) thereof.

Suitable polyolefins in the context of the invention are homo- and copolymers containing polymerized alkenes. Polyolefins may additionally also contain repeat units derived from other ethylenically unsaturated hydrocarbons in polymerized form.

Preference is given to homo- and copolymers containing at least one alpha-olefin in polymerized form. Examples of alpha-olefins are ethylene, prop-1-ene, but-1-ene, pent-1-ene, hex-1-ene, oct-1-ene or dec-1-ene.

Examples of polyolefins used with preference are polyethylenes, polypropylenes or copolymers of ethylene and propylene. Further examples are copolymers of ethylene and/or propylene with at least one further olefin or diolefin with a higher number of carbon atoms, such as but-1-ene, butadiene, isobutene, pent-1-ene, isoprene, hex-1-ene, hept-1-ene, oct-1-ene, non-1-ene, dec-1-ene, undec-1-ene, dodec-1-ene, etc.

Suitable hotmelt adhesives are also modified polyolefins. This is understood to mean a copolymer containing at least one alkene, especially at least one alpha-olefin, and at least one comonomer, preferably selected from ethylenically unsaturated acids or anhydrides thereof, esters of (meth)acrylic acid, ethylenically unsaturated epoxy compounds and mixtures thereof, in copolymerized form.

Preference is given to polyethylene (PE), polypropylene (PP), amorphous polyalphaolefins (APAO), etc.

In particular, the further hotmelt adhesive other than polyalkylene succinates is selected from biodegradable and/or compostable thermoplastic polymers. These include biodegradable and/or compostable polyesters and/or thermoplastic polyurethanes. In particular, the further biodegradable and/or compostable hotmelt adhesives other than polyalkylene succinates are selected from polycaprolactone, polyhydroxyalkanoates, polylactide, aliphatic-aromatic copolyesters, thermoplastic polyurethanes and mixtures (blends) thereof.

Polycaprolactone (PCL) is a biodegradable and compostable thermoplastic that can be produced by ring-opening polymerization of ϵ-caprolactone.

Suitable polyhydroxyalkanoates (PHA) (also referred to as polyhydroxy fatty acids (PHF)) are poly(3-hydroxypropionate) (PHP), poly(3-hydroxybutyrate) (polyhydroxybutyric acid, PHB), poly(3-hydroxyvalerate) (PHV), poly(3-hydroxyhexanoate) (PHHx), poly(3-hydroxybutyrate-co-3-hydroxyvalerate) (PHBV), etc.

A preferred polyhydroxyalkanoate is poly(3-hydroxybutyrate).

Polyhydroxyacetic acid, also called polyglycolic acid (PGA), can be prepared by anionic polymerization of glycolide, the dimer of hydroxyacetic acid. The higher polyhydroxyalkanoates are both biodegradable and/or compostable, and available from renewable (nonfossil) sources. Poly(3-hydroxybutyrate) (PHB) is formed by various bacteria by fermentation of carbohydrates with controlled supply of nutrients.

Polylactide (polylactic acid, PLA) can be produced by direct synthesis, i.e. polycondensation, of lactic acid. The lactic acid used as reactant can be produced by biotechnological means by fermentation of carbohydrates. For instance, proceeding from starch, glucose can be prepared by enzymatic hydrolysis, and lactic acid therefrom with the aid of Lactobacillus cultures. Alternatively, polylactic acid can be produced by ring-opening polymerization of lactide.

In the context of the invention, the term “aliphatic-aromatic copolyester” (AAC) refers to a polyester incorporating at least one aromatic dicarboxylic acid, at least one aliphatic diol and at least one further aliphatic component. The further aliphatic component is preferably selected from aliphatic dicarboxylic acids, hydroxycarboxylic acids, lactones and mixtures thereof. AAC) generally biodegradable and/or compostable.

The aliphatic-aromatic copolyesters (AAC) are preferably selected from copolyesters of butane-1,4-diol, adipic acid and terephthalic acid (PBAT), copolyesters of butane-1,4-diol, terephthalic acid and succinic acid, and copolyesters of butane-1,4-diol, terephthalic acid, isophthalic acid, succinic acid and lactic acid (PBSTIL). Preference is given to polybutylene adipate terephthalate (PBAT). PBAT is commercially available under the Ecoflex brand name from BASF SE.

Thermoplastic polyurethanes based on renewable raw materials are commercially available from Covestro AG under the Desmopan EC name.

For the particle size distribution and average particle size of the further hotmelt adhesives, the details relating to the polyalkylene succinates and specifically the polybutylene succinates are analogously applicable. The bonding compound structures used in the thermally fusible sheet materials according to the invention preferably contains hotmelt adhesives having an overall average particle size (based on all hotmelt adhesive particles present in the bonding compound structure) in the range from >0 to 1000 μm (micrometres), more preferably from 10 to 800 μm. For paste printing, preference is given to using an aqueous dispersion including hotmelt adhesives having an average particle size of >0 to 100 μm, more preferably of >0 to 80 μm. For application of the bonding compound structure to the backing ply by a scattering method, preference is given to using hotmelt adhesives having an average particle size of 50 to 300 μm, more preferably of 80 to 250 μm. Preferably, the particle composition of the hotmelt adhesives for a scattering method includes essentially no dust component of particles having a particle size of less than 80 μm. For application of the bonding compound structure to the backing ply by a powder point method, the hotmelt adhesives preferably have an overall average particle size of >0 to 500 μm.

Binders in the context of the invention (=component iii)) are polymers other than hotmelt adhesives, which may be physically crosslinking binders and/or chemically crosslinking binders. Suitable binders are selected from acrylate homo- and copolymers, styrene-acrylate copolymers, butadiene-acrylate copolymers, ethylene-vinyl acetate copolymers, styrene-butadiene copolymers (SBR), acrylonitrile-butadiene copolymers, polyurethanes, polyurethane acrylates and mixtures (blends) thereof. Preferred copolymers of polystyrene are styrene-butadiene copolymers.

The bonding compound structure may contain at least one additive (=component iv)), preferably selected from plasticizers, antioxidants, UV stabilizers, crosslinkers, fillers and reinforcers, dyes, levelling aids, emulsifiers, thickeners, tackifiers (tackifying resins), flame retardants, conductivity-improving components, encapsulated substances (such as fragrances, dyes, etc.), odour-absorbing substances (such as cyclodextrins, PVP, etc.), microbicidal substances, activated carbon, superabsorbent materials, ion exchangers and mixtures thereof. Each individual additive may preferably be present in an amount of 0.1% to 70% by weight, more preferably of 5% to 60% by weight, based in each case on the total weight of the bonding compound structure.

The bonding compound structure is preferably free of added water and other solvents.

Backing Ply

The thermally fusible sheet material according to the invention comprises a backing ply (also denoted as support layer) composed of a textile material, i.e. a textile sheet material. The textile material to be used for the backing ply is selected with regard to the desired intended use or the particular quality requirements. Suitable examples are woven fabrics, knitted fabrics, warp-knitted fabrics, nonwoven fabrics or the like, and combinations of two or more of the aforementioned textile materials. The invention fundamentally does not set any limits at all here. The person skilled in the art is also able here to easily discover the combination of materials suitable for the respective application.

The backing ply may contain fibres, i.e. threads of finite length (called staple fibres with lengths up to the decimetre range), filaments, i.e. threads of virtually infinite length, and combinations thereof. The fibres and filaments of the backing ply may be uncrimped, crimpable or crimped. The backing ply may be of single layer or multi layer structure.

The fibres used for production of the backing ply can be characterized via their linear density, i.e. weight based on a particular length. The linear density of the fibres is reported in dtex (1 dtex=0.1 tex or 1 gram per 10000 meters). The textile sheet materials used in accordance with the invention may in principle consist of any fibre types of a wide variety of different linear density ranges. The backing material preferably comprises fibres having a linear density in the range from 0.5 to 10 dtex or consists of fibres having a linear density in the range from 0.5 to 10 dtex. More preferably, the backing material comprises fibres having a linear density in the range from 0.8 to 6.7 dtex or consists of fibres having a linear density in the range from 0.8 to 6.7 dtex.

The basis weight of the backing ply is preferably 6 to 500 g/m², more preferably 20 to 350 g/m², especially 30 to 200 g/m².

In a preferred embodiment, the backing ply comprises at least one nonwoven fabric, or the backing ply consists of at least one nonwoven fabric.

Particularly preferably, the fibre webs for the nonwoven fibres are produced using staple fibres. The fibre webs may be produced by different web formation techniques. These include, for example, drylaid fibre webs, fibre webs obtained by the spunbond method, or fibre webs obtained by the meltblown method. In order to produce the nonwoven fabrics, the individual fibres laid out in a fibre web may be subjected to consolidation. Methods of nonwoven consolidation are known to the person skilled in the art and include mechanical, chemical or thermal consolidation methods.

In the case of mechanically bonded nonwoven fabrics, the fibre web is consolidated by mechanical interlooping of the fibres. For this purpose, preferably a needling technique is used, or interlooping by means of water jets or steam jets. The needling results in soft products. The basis weight of the backing plies obtained by mechanical needling is generally greater than 50 g/m². This can be too heavy for various interlining applications. By consolidation with water jets, it is possible to produce nonwoven fabrics with lower base weights.

In the case of chemically bound nonwovens, the fibre web is adhesively consolidated with a binder. The binders may be used, for example, in solid form, as a free-flowing composition, or in the form of binder fibres. The binding is effected, for example, in a dot pattern or over an area by means of a coagulated or filmed binding liquid, a melt of powders, or by means of softened or molten binding fibres. Suitable binders are known to the person skilled in the art and include, for example, chemically crosslinking polymers, for example a mixture of ethyl acrylate and butyl acrylate with the customary crosslinker groups, which are especially used in the form of dispersions. Alternatively, it is possible to use compositions containing thermoplastic polymers, for example in the form of powder or in combination with a finely divided filler material. These bring about consolidation of the fibres in the treated regions of the fibre web. Examples of this type of thermoplastic polymer binder are polyolefin powder, especially polyethylene or polypropylene powder, preferably copolyester powder with melting range >150° C. Further examples of binders can be found in U.S. Pat. No. 5,366,801, WO-A-02/12,607, WO-A-02/59,414 and WO-A-02/95,314. Also known is the use of bicomponent fibres or filaments as binding fibres for nonwoven production. They may be utilized in the form of core-shell fibres or filaments having a low-melting shell component as binding fibre in the thermal consolidation of nonwoven fabrics—over an area or in a dot pattern. The fibre web may be provided with a binder and then consolidated, for example, by impregnation, spraying, application/introduction of thermoplastic powder by scattering, blending with binding fibres, or by means of otherwise customary application methods.

For this purpose, the treated fibre web, after the application of the binder material, may be subjected, for example, to treatment by heating, optionally under pressure. This can be effected in a manner known per se.

Thermally bound nonwoven fabrics are typically consolidated by calendering or by hot air for use as interlining. The standard technology that has nowadays become established for interlining nonwovens is calender consolidation in a dot pattern. The fibre web generally consists here of fibres of polyester or polyamide that have been specifically developed for this process, and is consolidated by means of a calender at temperatures around the melting point of the fibres, wherein one roll of the calender is provided with a dot engraving.

The different methods described above for production of textile sheet materials are known and are described in textbooks and in the patent literature.

In a specific embodiment, the textile sheet material includes a backing material that has been subjected to hydrophobization with at least one customary hydrophobizing agent. Hydrophobizing agents are known to the person skilled in the art and specifically include fluorocarbons, silicones, paraffins and combinations thereof.

In a specific embodiment, the textile sheet material includes a backing material based on a meltblown fibre nonwoven. The meltblown method is known and is described in various patents and publications.

Textile sheet materials that include a backing material based on a meltblown fibre nonwoven and the production thereof are described in DE 10 2019 106995, to which reference is made here in full.

The fibres and filaments used for production of the textile sheet materials may consist of synthetic fibres, natural fibres or combinations thereof.

The fibres and filaments of the textile material of the backing ply are preferably selected from polyester fibres, polyacrylonitrile fibres (acrylic fibres), aliphatic or semi aromatic polyamide fibres, polyaramid fibres, polyamideimide fibres, polyolefin fibres, polyesteramide fibres, carbon fibres, polyvinylalcohol fibres, man-made cellulose fibres, fibres of cotton, linen (flax), jute, sisal, coconut, hemp, bamboo, wool, silk, animal hair fibres from alpaca, llama, camel, angora, mohair, cashmere, horsehair, fibres of chitin, chitosan, plant proteins, keratin and mixtures thereof.

The textile material of the backing ply preferably contains biodegradable and/or compostable fibres and/or filaments. Fibres and filaments present in the textile material of the backing ply are preferably biodegradable and/or compostable to an extent of at least 50% by weight, more preferably to an extent of at least 75% by weight, especially to an extent of at least 90% by weight, based on the total weight of the fibres and filaments.

Synthetic fibres are preferably selected from polyester fibres, polyamide fibres, polyolefin fibres, polyacrylonitrile fibres, polyurethane fibres and mixtures thereof.

Natural fibres are preferably selected from cotton, linen (flax), hemp, wool, silk and mixtures thereof.

Preferred synthetic fibres composed of natural polymers are man-made cellulose fibres. The expression “man-made cellulose fibres” (industrially manufactured cellulose fibres) includes non-derivatized cellulose fibres and derivatized cellulose fibres. For production of non-derivatized cellulose fibres, solid cellulose in the form of chemical pulp is first dissolved in a suitable solvent and then subjected to fibre formation with resolidification. The non-derivatized cellulose fibres thus obtained are also referred to as regenerated cellulose fibres. Regenerated cellulose fibres are preferably produced by the lyocell method in which N-methylmorpholine N-oxide is used as solvent. Lyocell fibres are offered for sale in a broad spectrum of linear densities by Lenzing AG under the Tencel® brand name. Alternatively, the cellulose can be derivatized by derivatization, for example by esterification with an organic or inorganic acid, and hence converted to a form of better solubility and then processed to fibres (cellulose ester fibres). Preference is given to using cellulose acetates for fibre formation.

The textile material of the backing ply preferably comprises fibres and filaments of aliphatic polyesters. These are especially selected from polylactic acid (PLA), poly(ethylene succinate) (PES), poly(butylene succinate) (PBS), poly(ethylene adipate) (PEA), poly(butylene succinate-co-butylene adipate) (PBSA), polyhydroxyacetic acid (PGA), poly(butylene succinate-co-butylene sebacate) (PBsu-co-BSe), poly(butylene succinate-co-butylene adipate) (PBSu-co-Bad), poly(tetramethylene succinate) (PTMS), polycaprolactone (PCL), polypropiolactone (PPL), poly(3-hydroxybutyrate) (PHB), poly(3-hydroxybutyrate-co-3-hydroxyvalerate) (PHBV), and mixtures thereof.

A specific embodiment of the aliphatic polyesters is that of the polyhydroxyalkanoates, such as poly(3-hydroxybutyrate), poly(4-hydroxybutyrate) (PHB) and poly(3-hydroxybutyrate-co-3-hydroxyvalerate) (PHBV). These are advantageously not just biodegradable and/or compostable, but also available from renewable (nonfossil) sources. Poly(3-hydroxybutyrate) (PHB) is formed by various bacteria by fermentation of carbohydrates with controlled supply of nutrients. Poly(3-hydroxybutyrate-co-3-hydroxyvalerate) (PHBV) can likewise be produced by fermentation from glucose and propionic acid.

The textile material of the backing ply preferably comprises fibres and filaments of aliphatic-aromatic copolyesters (AAC). These are generally biodegradable and/or compostable. The aliphatic-aromatic copolyesters (AAC) are preferably selected from copolyesters of butane-1,4-diol, terephthalic acid and adipic acid (BTA), copolyesters of butane-1,4-diol, terephthalic acid and succinic acid, copolyesters of butane-1,4-diol, terephthalic acid, isophthalic acid, succinic acid and lactic acid (PBSTIL). Also suitable are mixtures (blends) of aliphatic-aromatic polyesters, such as polyethylene terephthalate (PET), polybutylene terephthalate (PBT), polyethylene isophthalate (PEIP), glycol-modified polyethylene terephthalate (PETG) with at least one of the aforementioned aliphatic polyesters. PETG is obtained by esterification of terephthalic acid with ethylene glycol and cyclohexane-1,4-dimethanol (CHDM).

In a specific embodiment, the textile material of the backing ply comprises at least one multicomponent fibre. Suitable multicomponent fibres include at least two polymer components. Preference is given to multicomponent fibres composed of two polymer components (bicomponent fibres). Suitable types of bicomponent fibres are sheath/core fibres, side-by-side fibres, matrix/fibril fibres (islands-in-the-sea) and slice-of-cake fibres. A preferred bicomponent fibre contains two polymer components selected from two different polyesters.

Application Method

The invention further provides a process for producing a thermally fusible sheet material as defined above and hereinafter, comprising providing of a backing ply composed of a textile material and applying a bonding compound structure by an application method. With regard to suitable and preferred embodiments of the backing ply, reference is made in full to the aforementioned suitable and preferred embodiments.

The bonding compound structure may be applied by customary methods to the backing ply composed of a textile material. It is possible here that the bonding compound structure is applied to the backing ply as a composition (mixture) of all components, or for the individual components of the bonding compound structure to be applied separately. The bonding compound structure may be applied to the entire surface area of the backing ply (over the full area) or to one or more subregions. Application to part of the area can be effected in the form of particular patterns, for example in the form of dots or strips. The bonding compound structure can be applied to the backing ply in one or more application steps. Identical or different application methods may be used in different application steps. Methods of applying the bonding compound structure or individual components thereof are known in principle. These specifically include spreading methods, powder point methods, paste print methods, double point methods, hotmelt methods, inkjet methods and combinations thereof.

The amount of bonding compound structure applied per unit area of the backing ply is preferably 1 to 80 g/m², more preferably 5 to 40 g/m².

In a first preferred embodiment, the bonding compound structure is applied in powder form to the backing ply composed of a textile material.

Hotmelt adhesives in powder form may be applied by spreading application, which is appropriate especially for bonding of porous substrates for the production of textile composites that are breathable overall. What is advantageous about spreading application is that it is a simple application method for applications on a large scale.

Since powders of thermally activatable hotmelt adhesives are capable of adhesion even at low temperatures, they are suitable for gentle lamination of thermally sensitive substrates, for example high-grade textiles. By virtue of good flow properties in the activated state, a good bond is established even at low pressure and with a short contact time; nevertheless, the risk of penetration through into the woven fabric is low.

The size of the particles is guided by the area to be printed, for example the desired size of a binding dot. In the case of a dot pattern, the particle diameter may vary between >0 μm and 500 μm. In principle, the particle size of the hotmelt adhesive is not uniform but follows a distribution, meaning that there is always a particle size spectrum. The particle size is appropriately matched to the desired amount applied, dot size and distribution.

In a further preferred embodiment, the bonding compound structure is applied by a double point method to the backing ply composed of textile material. The double point method is particularly capable with regard to the bonding of the thermally fusible sheet material, for example to an outer fabric, to care treatment and in relation to back-riveting. The double points have a two-layer construction, meaning that they consist of an underpoint and an overpoint. The underpoint penetrates into the backing material and serves as barrier layer against adhesive compound penetration and for anchoring of the overpoint particles. Customary underpoints consist, for example, of at least one binder and/or at least one adhesive. When the underpoint contains at least one hotmelt adhesive, this is selected from polyalkylene succinates, the aforementioned further suitable thermoplastic polymers and mixtures thereof. If the underpoint contains at least one hotmelt adhesive, this also contributes to bond strength in the fusion operation. According to the composition, the underpoint, as well as anchoring in the base material, also contributes to prevention of adhesive compound penetration as a barrier layer.

The double point is preferably applied to the backing ply in a pattern of essentially round dots, with the dot pattern in a regular or irregular distribution. The double point is not limited here to a pattern of round points, but may be applied in any geometry, for example including in the form of lines, strips, mesh- or lattice-like structures, dots with rectangular, rhomboid or oval geometry, or the like.

The main adhesive component in the two-layer construction is generally primarily the overpoint. Thus, the overpoint preferably includes at least one hotmelt adhesive. The hotmelt adhesive of the overpoint is preferably selected from polyalkylene succinates, the aforementioned further suitable thermoplastic polymers and mixtures thereof. The overpoint preferably includes at least one polyalkylene succinate as hotmelt adhesive.

The overpoint more preferably includes at least one polybutylene succinate as hotmelt adhesive.

In a specific embodiment, the material of the overpoint is scattered in powder form onto the underpoint. After the scattering operation, the excess portion of the powder (between the dots of the lower layer) is appropriately sucked away again. After subsequent thermal treatment, the overpoint is bound to the underpoint and may serve as adhesive to the overpoint.

The number of points, the amount of bonding compound structure applied to the backing ply and geometry of the dot pattern may vary depending on the end use of the interlining. In a suitable embodiment, the composition for the underpoints is applied to the backing ply by a printing method, for example by means of a rotary screen printing technique. Printing can be effected with customary print templates, for example with a CP 110 template, corresponding to a clear area of 20%, or with a CP 52 template, corresponding to a clear area of 15%.

In a further preferred embodiment, the bonding compound structure is applied by a paste printing technique to the backing ply composed of the textile material. In this methodology, a printing paste is used and is applied to the backing ply by means of a printing method, specifically by means of a rotary screen printing method. For production of the print paste, preference is given to using an aqueous dispersion of the thermoplastic polymers used as hotmelt adhesive. The hotmelt adhesives preferably have an average particle size of <80 μm. Formulations for print pastes generally comprise further components, such as thickeners, flow aids, etc. After the application of the bonding compound structure to the backing ply, the printed backing layer is appropriately subjected to a drying process.

The thermally fusible sheet material according to the invention can be used as interlining, lining or outer fabric. The invention also relates to use for these purposes, especially for production of textile products in the form of clothing, shoes, upholstered furniture, carpets, bed and table covers, curtains, towels, cleaning cloth, filters, meshes, etc.

The thermally fusible sheet materials according to the invention are also suitable for production of footwear, components for vehicle equipment and the construction sector, and different industrial textiles.

The thermally fusible sheet materials according to the invention are especially suitable for production of biodegradable and/or compostable textile products.

Items of Clothing and Use of the Thermally Fusible Sheet Material

The invention further provides an item of clothing comprising a thermally fusible sheet material as defined above in thermally fused form. With regard to the thermally fusible sheet material and the thermal fusion thereof, for example with customary fusion presses, reference is made in full to the corresponding passages of this document.

The item of clothing is especially selected from men's clothing, women's clothing, girls' clothing, boys' clothing, children's clothing, underclothing (underwear), outerwear, spring clothing, summer clothing, autumn clothing, winter clothing, outdoor clothing, indoor clothing, protective clothing, workwear, legwear, armwear, skirtwear, torsowear, single-sided, double-sided, lined and unlined clothing. In the context of the invention, the term “item of clothing” also includes semifinished items of clothing and clothing accessories.

The invention also provides for the use of a thermally fusible sheet material, as defined herein, as interlining for production of outerwear, preferably shirts, blouses and polo shirts. They especially serve as interlining for collars, cuffs or button plackets. In men's clothing, they may be used for canvas articles, sleeveheads, shoulder pads, and for fusion of front portions of suit jackets, and in women's clothing for fusion of blazer portions. The thermally fusible sheet materials according to the invention are also suitable for casual wear, sportswear and functional clothing, for example for interlining that can be readily fused to the outer fabric and remains securely bonded, even after punishing washing methods. Workwear and protective clothing for everyday use has to be (highly) functional and durable since it is frequently subjected to extreme cleaning methods and must withstand high washing and finishing temperatures and be resistant to wear. In addition, it has to withstand frequent changes in size and the fit has to be preserved in a sustained manner. This is equally true of protective clothing that provides protection from fire, heat or extreme cold. For production of children's clothing, nonwoven interlining is ideal for collars, cuffs, waistbands and borders.

Specific embodiments for use of the thermally fusible sheet materials according to the invention are:
In suits, jackets and blazers for
front portion pieces,
top and bottom collars,
cuff links,
flaps, tongues, pleats, slits, ribbons, yokes,
chest pieces,
felt pieces,
shoulder pieces
pockets, stay pieces,
buckles,
belts,
In jackets for
complete lining front,
chest pieces,
cuffs, flaps, tongues, belts, slits, yokes, lower seam tapes, epaulettes, top and
bottom collars,
sleeve buttons,
fur collars as specific support fabric
thermal insulation
trapunto quilting,
In wool clothing, sports clothing, outer clothing for
complete clothing front,
entire facing,
lapels,
top and bottom collars
epaulettes, belts,
flaps, tongs, slits, yokes, seam tapes,
specific fillings,
In dresses for
open and closed facings,
collars,
cuffs,
pockets, flaps, tongues, slits, yokes,
epaulettes and belts,
neck facings,
waist bands,
edge tapes,
In shirts for
collars, top and bottom collars,
facings,
button plackets,
cuffs,
neck bands,
In trousers for
waistbands,
fly linings,
extension tabs,
pocket flaps,
pocket patches,
belt loop fillers,
In blouses for
collars, top and bottom collars,
facings,
button plackets,
cuffs,
pleat stabilizers.

The textile sheet materials modified in accordance with the invention may be bonded in a manner known per se to a textile shell (outer fabric) to be reinforced.

According to the invention, it is possible to use a wide variety of different outer fabrics, for example PES, cotton or cambric outer fabrics.

However, the use of a thermally fusible sheet material according to the invention is not limited to that application. Other applications are also conceivable, for example as fusible textile sheet material in domestic textiles such as upholstered furniture, reinforced seat constructions, seat covers, or as fusible and extensible textile sheet material in automobile equipmentor in shoe components.

The invention is described in detail by the examples that follow, which do not restrict the general disclosure.

### EXAMPLES

For the bonding compound structures according to the invention and the thermally fusible sheet materials based thereon, a polybutylene succinate (PBS) having a melt flow index (MFI), determined according to DIN EN ISO 1133-1 at 190° C. and a load of 2.16 kg, of 22 g/10 minutes and a melting point of 115° C. was used as hotmelt adhesive. The polybutylene succinate is compostable within the meaning of DIN EN 13432:2000-12.

For the comparative examples, a polycaprolactone (PCL) having a melt flow index (MFI), determined according to DIN EN ISO 1133-1 at 160° C. and a load of 2.16 kg, of 19 g/10 minutes and a melting point of 55-65° C. was used as hotmelt adhesive. The polycaprolactone is likewise compostable within the meaning of DIN EN 13432:2000-12.

### Example 1

A woven fabric made of 100% cotton with a basis weight of 125 g/m² was coated by the powder point method. In the coating process, in the respective case, powders of polybutylene succinate and polycaprolactam with a particle size in the range of 0-180 μm (micrometres) were applied to the woven fabric base with a CP 152 gravure role (powder point calender) in an application rate of 28 g/m².

The fusion of the interlining to an outer fabric (50% cotton and 50% polyester in the form of a shirt poplin fabric) was then undertaken by treatment in a shirt press at a preheating temperature of 130° C. and a main heating temperature of 150° C. and at a pressure of 1 bar for 12 seconds.

Subsequently, the composite was washed once with a heavy duty laundry detergent at 40° C. and dried in each case at room temperature for 24 hours.

Table 1 shows the bond strength values without and with wash treatment and/or storage at elevated temperature and under humid conditions in a climate-controlled cabinet. The average from 3 individual measurements is reported in each case.

TABLE 1

| | Hotmelt adhesive/ | |
|---|---|---|
| | bond strength [N/5 cm] | |
| | PCL | PBS |
| Treatment | (comp.) | (inv.) |
| Untreated | 22.5 | 19.2 |
| 1 × 40º wash | 18.1 | 11.0 |
| After storage for 2 weeks at | 0.0^{a)} | 19.4 |
| 60° C. and 80% humidity | | |
| After 1 × 40º wash and storage for | 0.0 | 17.4 |
| 2 weeks at 60° C. and 80% humidity | | |
| After storage for 4 weeks at | 0.0 | 17.3 |
| 60° C. and 80% humidity | | |
| After 1 × 40º wash and storage for | 0.0 | 15.9 |
| 4 weeks at 60° C. and 80% humidity | | |

^{a)}a value of 0.0 in the table means ″no adhesion″

It has been shown that the adhesive system according to the invention based on polybutylene succinate-coated interlining nonwovens affords composite coatings that feature high wash resistance and storage stability at elevated temperature and humidity. Composite coatings based on polycaprolactone as hotmelt adhesive also show very good adhesion values without any treatment. However, they do not have adequate storage stability specifically at elevated temperature and humidity.

Table 2 shows strength values without treatment by dry cleaning and/or storage at elevated temperature and humidity in a climate-controlled cabinet. A hydrophobized outer fabric composed of 55% polyester and 35% cotton was used. The average from 3 individual measurements is reported in each case.

TABLE 2

| | Hotmelt adhesive/ | |
|---|---|---|
| | bond strength [N/5 cm] | |
| | PCL | PBS |
| Treatment | (comp.) | (inv.) |
| Untreated | 26.8 | 13.8 |
| 1 × dry cleaning | 0.0 | 14.5 |
| After storage for 2 weeks at | 0.0 | 23.0 |
| 60° C. and 80% humidity | | |
| After 1 × dry cleaning and storage for | 0.0 | 20.7 |
| 2 weeks at 60° C. and 80% humidity | | |
| After storage for 4 weeks at | 0.0 | 29.3 |
| 60° C. and 80% humidity | | |
| After 1 × dry cleaning and storage for | 0.0 | 17.2 |
| 4 weeks at 60° C. and 80% humidity | | |

A value of 0.0 in the table means ″no adhesion″

It has been shown that the adhesive system according to the invention based on polybutylene succinate-coated interlining nonwovens affords composite coatings that feature high stability to dry cleaning. This is a crucial advantage over composite coatings based on polycaprolactone as hotmelt adhesive.

### Example 2

A nonwoven base composed of 100% polyester with a basis weight of 34 g/m² was coated by the paste printing method. For this purpose, the nonwoven was printed in a rotary screen printing machine with an adhesive dispersion in a dot pattern of 110 dots/cm² with a dry application rate of 18 g/m². The printed nonwoven is subjected to a thermal treatment in a laboratory drier at 160° C. for 30 seconds.

The adhesive dispersion was of the following composition:
30 parts by weight of hotmelt adhesive having a particle fraction of 0-80 μm
10 parts by weight of thickeners, wetting agents, further additives
60 parts by weight of water
Viscosity: 32 000 cP, pH: 6.6

The interlining was fused to a hydrophobized shell (65% polyester and 35% cotton) by treatment in a continuous press at a temperature of 120 or 140° C. and a pressure of 2.5 bar for 12 seconds.

Table 3 gives the bond strength values without and with wash treatment. The average from 3 individual measurements in each case is reported.

TABLE 3

| | Hotmelt |
|---|---|
| | adhesive/bond |
| | strength [N/5 cm] |
| | PBS |
| Treatment | (inventive) |
| Fusion temperature | 10.3 |
| 120° C. untreated | |
| Fusion temperature | 12.3 |
| 140° C. untreated | |
| Fusion temperature | 10.4 |
| 120° C. 1 × 60º wash | |

1. A thermally fusible sheet material, comprising a backing ply composed of a textile material and bearing a bonding compound structure, wherein the bonding compound structure comprises at least one polyalkylene succinate as hotmelt adhesive.

2. The thermally fusible sheet material according to claim 1, wherein the polyalkylene succinate is selected from the polycondensation products of succinic acid with at least one polyol selected from butane-1,4-diol, butane-2,3-diol, propane-1,3-diol, propane-1,2-diol, ethylene glycol and mixtures thereof.

3. The thermally fusible sheet material according to claim 1, wherein the bonding compound structure comprises at least one polybutylene succinate.

4. The thermally fusible sheet material according to claim 1, wherein the bonding compound structure does not contain any conjugated diene-based polymers modified with polar functional groups.

5. The thermally fusible sheet material according to claim 1, wherein the bonding compound structure includes at least one polyalkylene succinate hotmelt adhesive having a melt flow index (MFI), determined to
DIN EN ISO 1133-1 at 190° C. with load 2.16 kg, of 1 to 200 g/10 minutes, preferably of 5 to 120 g/10 minutes, especially of 10 to 80 g/10 minutes.

6. The thermally fusible sheet material according to claim 1, wherein the bonding compound structure contains at least one polyalkylene succinate having a melting point in the range from 60 to 190° C., preferably from 90 to 150° C., especially from 100 to 130° C.

7. The thermally fusible sheet material according to claim 1, wherein the bonding compound contains at least one further hotmelt adhesive other than polyalkylene succinates.

8. The thermally fusible sheet material according to claim 1, wherein the bonding compound contains at least one further hotmelt adhesive other than polyalkylene succinates, selected from biodegradable and/or compostable thermoplastic polymers.

9. The thermally fusible sheet material according to claim 1, wherein the bonding compound structure takes the form of a two-ply bonding compound structure comprising a lower layer directly atop the sheet material and an upper layer disposed atop the lower layer, wherein the lower layer and/or the upper layer comprises at least one polyalkylene succinate as hotmelt adhesive.

10. The thermally fusible sheet material according to claim 1, wherein the backing ply contains fibres that are biodegradable and/or compostable, the backing ply preferably consisting to an extent of at least 50% by weight, based on the total weight of the fibres used, of fibres that are biodegradable and/or compostable.

11. A process for producing a thermally fusible sheet material as defined in claim 1, comprising providing a backing ply composed of a textile material and applying a bonding compound structure by an application method, selected from spreading methods, powder point methods, paste print methods, double point methods, hotmelt methods, inkjet methods and combinations thereof.

12. An item of clothing comprising a thermally fusible sheet material as defined in claim 1 in thermally fused form.

13. The thermally fusible sheet material as defined in claim 1, wherein the thermally fusible sheet material is an interlining, lining or outer fabric for production of textile products.

14. The thermally fusible sheet material as defined in claim 1, wherein the thermally fusible sheet material is used for production of biodegradable and/or compostable textile products.

15. The thermally fusible sheet material as defined in claim 1, wherein the thermally fusible sheet material is
an interlining for production of outerwear
in men's clothing and women's clothing in front panels in the form of interlining and ribbons for the stabilization of small components and lapels, in canvas interlining for lined or unlined coats,
in women's clothing as waistband interlining for skirts and trousers,
in clothing accessories,
for needlework and sewing, and
as padding with adhesives.

16. The thermally fusible sheet material according to claim 7, wherein the at least one further hotmelt adhesive is selected from polyesters, polyolefins, polyamides, polyurethanes, polyacrylates, styrene-isoprene copolymers, styrene-butadiene copolymers, ethylene-vinyl acetate copolymers and mixtures thereof.

17. The thermally fusible sheet material according to claim 8, wherein the biodegradable and/or compostable thermoplastic polymers are selected from polycaprolactone, polyhydroxyalkanoates, polylactide, aliphatic-aromatic copolyesters, thermoplastic polyurethanes and mixtures thereof.

18. The item of clothing of claim 12, wherein the item of clothing is selected from men's clothing, women's clothing, girls' clothing, boys' clothing, children's clothing, underclothing (underwear), outerwear, spring clothing, summer clothing, autumn clothing, winter clothing, outdoor clothing, indoor clothing, protective clothing, workwear, legwear, armwear, skirtwear, torsowear, single-sided, double-sided, lined and unlined clothing, semifinished items of clothing and clothing accessories.

19. The thermally fusible sheet material of claim 13, wherein the interlining, lining or outer fabric for production of textile product is in clothing, shoes, upholstered furniture, carpets, bed and table covers, curtains, towels, cleaning cloths, filters, meshes, and for production of footwear, components for vehicle equipment and the construction sector, and different industrial textiles.

20. The thermally fusible sheet material of claim 15, wherein the outerwear is shirts or blouses, and the thermally fusible sheet material is used for fusion of leading edges, busts, collars, sleeves, button plackets, cuffs, flaps and/or pleats, and
wherein the clothing accessories are bands for hats and hat reinforcements.
